(19) United States
(12) Patent Application Publication
(10) Pub. No.: US 2026/0365496 A1
(43) Pub. Date: Nov. 19, 2026

(54) Relative Control for Automatic Container Placement on a Receiver Unit

(71) Applicant: ABB Schweiz AG, Baden (CH)

(72) Inventors: Fredrik Ljungberg, Västerås (SE); Soroush Rastegarpour, Västerås (SE); Mihir Champaneria, Västerås (SE); Dalila Alibegovic, Västerås (SE); Fredrik Botling, Västerås (SE)

(73) Assignee: ABB Schweiz AG, Baden (CH)

(21) Appl. No.: 19/681,580

(22) Filed: May 19, 2026

(30) Foreign Application Priority Data
May 19, 2025 (EP) 25177479.0

(51) Int. Cl. B66C 13/46

(52) U.S. Cl. CPC B66C 13/46

(57) ABSTRACT

A method for automated landing control of a container on a receiver unit comprising locking devices for the container, the method comprising determining, by a control unit, using the at least one sensor of a container handling device, a first pose being a pose of a set of locking devices of the receiver unit relative at least one marker being fixed and adjacent the receiver unit, determining, by the control unit, using at least one sensor of the container handling device, a second pose being a pose of the container relative the at least one fixed marker, and providing, by the control unit, a control signal, for adjusting the pose of the container relative the receiver unit based the determined first and second poses.

### CROSS-REFERENCE TO RELATED APPLICATIONS

The instant application claims priority to European Patent Application No. 25177479.0, filed May 19, 2025, which is incorporated herein in its entirety by reference.

### FIELD OF THE DISCLOSURE

The present disclosure generally relates to a computer implemented method for automated landing control of a container on a receiver unit, to a control unit, to a system, to a spreader, and to a computer program product.

### BACKGROUND OF THE INVENTION

The automation of port operations includes the automatic placement of containers onto for example truck chassis using cranes. Containers are typically handled by spreaders, which use corner locking mechanisms to secure them. Sensors, such as cameras mounted on the spreader, can be used to detect the position of twist locks on the truck chassis and guide container placement.

However, during the final stage of placement, the container itself often obstructs the sensors. This occlusion limits the effectiveness of placement control near the ground. As a result, placement accuracy suffers due to reduced robustness to disturbances during the final stage of placement.

### BRIEF SUMMARY OF THE INVENTION

In view of the above-mentioned and other drawbacks of the prior art, it is an object of the present invention to provide a method that at least partly alleviates the drawbacks of prior art.

According to a first aspect of the disclosure, there is provided a computer implemented method for automated landing control of a container on a receiver unit comprising locking devices for the container, the method comprises the steps of: determining, by a control unit, using the at least one sensor of the container handling device, a first pose being a pose of a set of locking devices of the receiver unit relative to at least one marker being fixed and adjacent the receiver unit, determining, by the control unit, using at least one sensor of the container handling device, a second pose being a pose of the container relative the at least one fixed marker, and providing, by the control unit, a control signal, for adjusting the pose of the container relative the receiver unit based the determined first and second poses.

The present disclosure is at least partly based on the realization of using detections of fixed markers that are off-board the receiving unit to perform relative control of positioning the container on the receiving unit. The positioning being such that the container is properly aligned with the locking device(s) of the receiving unit. This provides for positioning the container correctly even when the locking devices are no longer detectable by sensors on the container handling device. Furthermore, the control unit can receive feedback for its control of the container position even with unknown tilt and panning angles of the sensors.

A pose is herein a spatial position and/or an orientation. The spatial position and/or orientation of one entity is relative to the spatial position and/or orientation of another entity.

The container has receivers where the locking devices can lock-in. Typically, such receivers are holes where the locking devices fit and can engage.

A fixed marker is a detectable anchor-point which is not moving or is very slow-moving relative to the receiver unit and the spreader. Typically, the fixed marker is a ground-based marker fixed to the ground. However, the fixed marker may be placed on fixed structures such as buildings or for example on the foot of a crane of the spreader.

In embodiments, the poses may be determined in a reference frame of the at least one sensor. Advantageously, by using the sensor's reference frame, feedback signals and error signals can be used with less need for recalibration of the sensor(s) compared to using world fixed coordinates.

In embodiments, the method may comprise determining a first error signal based on a difference in pose between the container and the set of locking devices, and adjusting the pose includes adjusting the position of the container to minimize the first error signal as the container is lowered towards the receiver unit while the set of locking devices are detectable by the at least one sensor. The first error signal advantageously utilizes that the set of locking devices are still detectable using the at least one sensor. The control unit may estimate the horizontal and vertical distances between a locking device and e.g., the corner of the container that should attach to the locking device as well as the horizontal and vertical distances between the locking device and the marker. Estimates of these distances in relation to known dimensions of the marker can readily be obtained from a tracking system employed by the control unit. The horizontal and vertical distance is here from the perspective of the sensor looking down at the container and receiver unit from above, e.g., it is the horizontal axis, x-axis, and the vertical axis, y-axis in a plane projected by the sensor.

In embodiments, the method may comprise determining a second error signal based on a difference between the first pose and the second pose, the first pose being a predetermined first pose, and adjusting the pose includes adjusting the horizontal position of the container to minimize the second error signal as the container is lowered towards the receiver unit. The first pose may be the distances, in both vertical and horizontal directions in the projected plane of the sensor, between the locking devices and the respective fixed marker as determined while the container is lowered. The second pose may be the distances, in both vertical and horizontal directions in the projected plane of the sensor, between the corner of the container or the receivers on the container and the respective fixed marker.

Note that the distance between the locking devices and the respective fixed marker is fixed since the marker is not moving relative to the receiving unit. The second error signal will tend to zero as the container gets closer to its target area including the locking devices and can thus be used to provide feedback during the final part of the container set down.

In embodiments, the method may comprise using the first error signal as long as the set of locking devices are detectable by the at least one sensor, and once the set of locking devices are no longer detectable, using the second error signal for adjusting the horizontal position of the container. The control unit may track the corner of the container or have predefined information of the location if the receiving devices of the container. Advantageously, the method switches to the second error signal to be used for feedback control once the set of locking devices are no longer detected by being blocked by the container, thereby providing for robust feedback to enable accurate positioning of the container despite the occluded locking devices.

In embodiments, the predetermined first pose may be determined while the locking devices are detectable. Advantageously, the distances between the locking device and the respective fixed marker are constant since the receiving unit is assumed to be standing still. This means that multiple approximate values of the distances can be obtained during the container landing and that refined and accurate estimates of the distances of the first pose can be determined.

In embodiments, the method may comprise determining an aggregate estimate value of multiple samples of a distance between the set of locking devices and the at least one fixed marker while the locking devices are detectable, wherein, the predetermined first pose includes the aggregate estimate value. The aggregate estimate may be for example an average value, a weighted average value, a filtered estimate, etc. Preferably, one aggregate estimate value is determined for the horizontal distance between the set of locking devices and the at least one fixed marker and one aggregate estimate value is determined for the horizontal distance between the set of locking devices and the at least one fixed marker.

In embodiments, the aggregate estimate value(s) may be determined while using the first error signal as feedback for moving the container. Thus, multiple samples of the distances between the set of locking devices and the at least one fixed marker are determined while the set of locking devices are still detectable.

In embodiments, the at least one fixed marker may be a marker having known dimensions, wherein poses between the fixed marker and container and/or the locking device are determined based on the known dimensions of the at least one fixed marker. It is plausible that the marker is an arbitrary land-fixed object like parts of a fence/crane or even a drawing in the asphalt.

In embodiments, the at least one fixed marker may be a fiducial marker. For example, the marker may be an Aruco or Charuco marker.

In embodiments, the method may comprise using at least two sensors, each associated with a corner of the container. For example, more than one camera sensor may be used to accurately detect an orientation of a spreader.

The sensors may be one or more of cameras and/or Lidars.

The locking device may be a twist-lock of a vehicle or trailer.

The present disclosure further describes a control unit configured to execute the method of any one of the herein disclosed embodiments.

There is further provided a system for automated landing control of a container on a receiver unit comprising locking devices for the container, the system comprising: at least one sensor for detecting poses of a set of locking devices of a receiver unit and fixed markers, and a control unit control unit configured to execute the method of any one of the herein disclosed embodiments.

There is further provided a spreader comprising the system. A spreader is a lifting device commonly used in port and terminal operations for handling intermodal containers. The spreader is typically attached to a crane and is designed to adjust its width to fit various container sizes, ensuring a secure and balanced lift. Equipped with twist locks or other securing mechanisms at each corner, the spreader engages with the container's corner castings, allowing it to lift, move, and place containers efficiently.

There is further provided a computer program product comprising program code for performing the method according to any one of the herein disclosed embodiments, when executed by a control unit.

Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE SEVERAL VIEWS OF THE DRAWING(S)

These and other aspects of the present invention will now be described in more detail, with reference to the appended drawings showing an example embodiment of the invention, wherein:

FIG. 1 schematically illustrates crane hoisting a spreader according to an embodiment of the invention;

FIG. 2 schematically illustrates a spreader landing a container on a truck chassis;

FIG. 3 is a top view of a container, a receiving unit, and a marker as seen from a sensor;

FIG. 4 is a flow-chart of method steps according to embodiments of the present invention;

FIG. 5 is a flow-chart of method steps according to embodiments of the present invention;

FIG. 6 is a top view of a container blocking a receiving unit, and a marker as seen from a sensor; and

FIG. 7 is a block diagram of a system according to embodiments of the present invention.

### DETAILED DESCRIPTION OF THE INVENTION

In the present detailed description, various embodiments of the present invention are herein described with reference to specific implementations. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the scope of the invention.

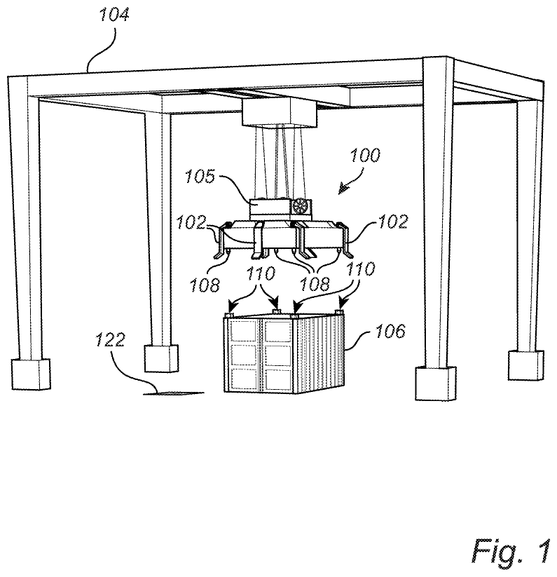

FIG. 1 schematically illustrates a container handling device 100 in the form of a spreader 100 attached to a crane 104 via a hoisting mechanism 105 which is configured to lift the spreader up and down for lifting the container 106. The spreader 100 can adjust its width to accommodate for different sized containers. The spreader 100 further includes flipper arms 102 configured to guide the spreader 100 into correct positioning on the container 106.

The flippers 102, equally termed flipper arms 102, are mounted on the sides of the spreader 100 and can move between up and down positions. In the up position, the flipper arms 102 facilitate the spreader's 100 alignment with the container 100, while in the down position, they help secure the container 106 by engaging with its sides. I FIG. 1, the flipper arms are in their down position as the crane 104 is lowering the spreader 100 towards the container 106. The crane 104 and the spreader 100 may be operated by a crane operator.

The spreader 100 includes locking devices, such as twist locks 108 which are adapted to lock into corresponding receivers 110 of the container, often in the form of receiver holes 110. The geometry of the twist locks ensures engagement in the receiving holes 110 once rotated while maintaining inserted in place in the receiving holes 110. There is further a fixed marker 122 on the ground.

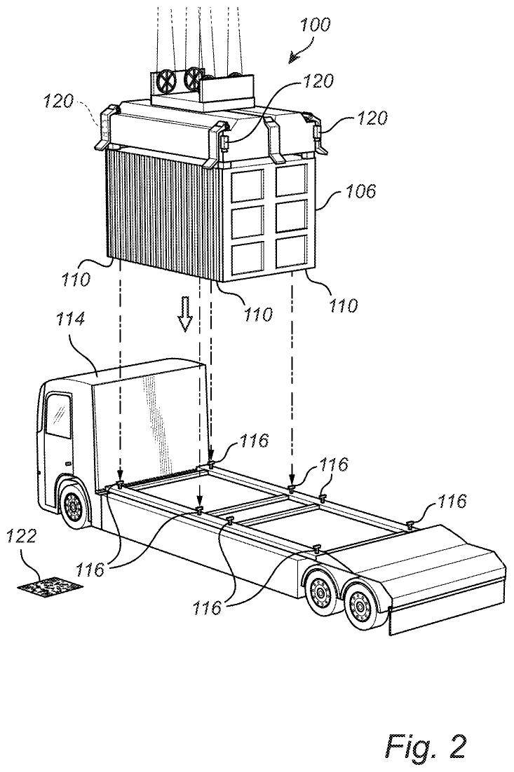

FIG. 2 illustrates the spreader 100 lowering the container towards a receiver unit 112 in the form of a truck 114. Other receiver units 112 are envisaged such as trains, trailers, boats, etc.

The truck 114 comprises locking devices 116 for the container 106. The locking devices 116 are here twist locks. The container 106 comprises corresponding receivers 110 at its bottom where the twist locks 116 engage.

The container handling device 100, e.g., spreader 100, comprises at least one sensor 120 configured to detect the locking devices 116 of the truck 114 or trailer as the container 106 is lowered. The spreader 100 can use the information from the sensors 120 to correctly position the container 106 on the truck 114.

During a first stage of lowering the container 106 towards the truck 114, the twist-locks 116 remain in sight of the sensors 120 and the alignment control of the container 106 with respect to the twist-locks 116 can be performed by direct detection of the twist locks 116. However, as the container 106 gets closer to the receiver unit 114, the container blocks the line of sight of the sensors 120 and the alignment of the container can no longer rely on direct detection of the twist-locks 116 of the truck 114. This situation is addressed by embodiments of the present disclosure.

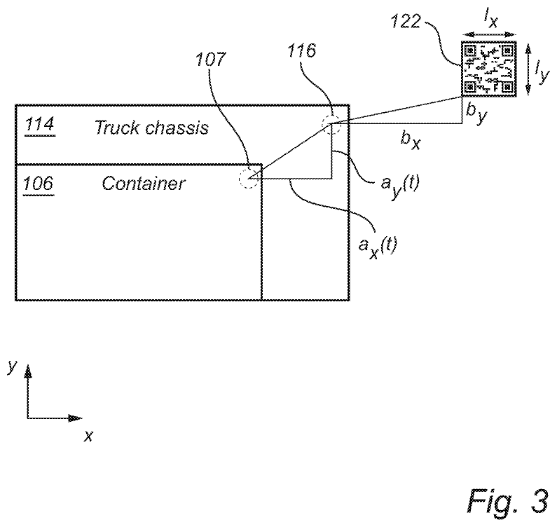

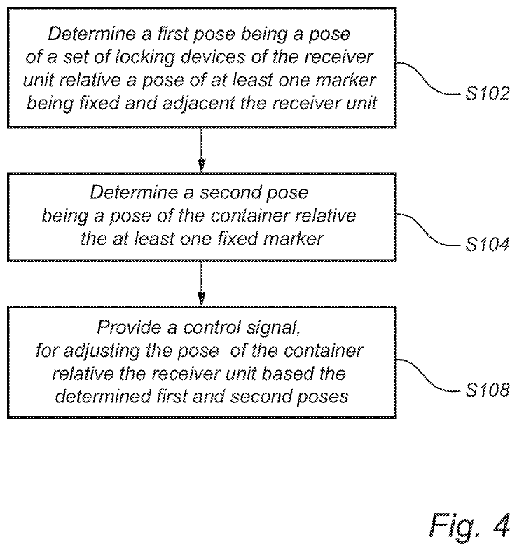

Turning to FIG. 3 in conjunction with the flow-chart in FIG. 4.

FIG. 3 is a schematic top view of the container 106 being lowered towards the receiver unit, e.g., a truck chassis 114, comprising at least one locking device, e.g., a twist lock 116. Adjacent the truck 114 is a marker 122 being fixed on the ground or on an adjacent structure. Different markers are possible such as land-fixed objects like parts of a fence/crane or even a drawing in the asphalt, as long as they are non-moving, or at least slow moving in relation to the motion of the container, such that it can be viewed as a non-moving anchor point.

In some embodiments, and as shown in FIG. 3, the marker 122 is a fiducial marker such as an Aruco or Charuco marker with known dimensions 1ₓ and l_{y} and known ID defining the binary matrix.

In step S102 determining, by a control unit of e.g., the spreader 100, using the at least one sensor 120 of the container handling device 100, a first pose being a pose of a set of locking devices 116 of the receiver unit 114 relative to a pose of at least one marker 122 being fixed and adjacent the receiver unit 114. The sensors 120 partly captures the schematic top view shown in FIG. 3, during a first stage of the lowering action of the container 106.

The sensors 120 may be for examples cameras and/or Lidars.

A pose relates to both position and orientation. Thus, a pose of one entity relative to a pose of another entity relates to the spatial displacement between the two entities and the orientation, e.g., rotational or angular displacement. The poses are preferably determined in a reference frame of the at least one sensor 120, meaning that time-consuming recalibration of the extrinsic sensor such as cameras 120 parameters required for expressing the poses in another reference frame such as the world-reference frame is not necessary.

In step S104, determining, by the control unit, using the at least one sensor 122 of the container handling device 100, a second pose being a pose of the container 106 relative the at least one fixed marker 122. That is, the control unit now has information about the pose of the twist-lock relative to the marker 122, and the pose of the container 106 relative to the marker 122.

Combined, the control unit may now determine and provide a control signal in step S108, for adjusting the pose of the container 106 relative to the receiver unit 116 based on the determined first and second poses. That is, even when the twist lock 116 is occluded by the container 106 during the later stage of the lowering, the control unit can align and position the container 106 on the twist lock 116.

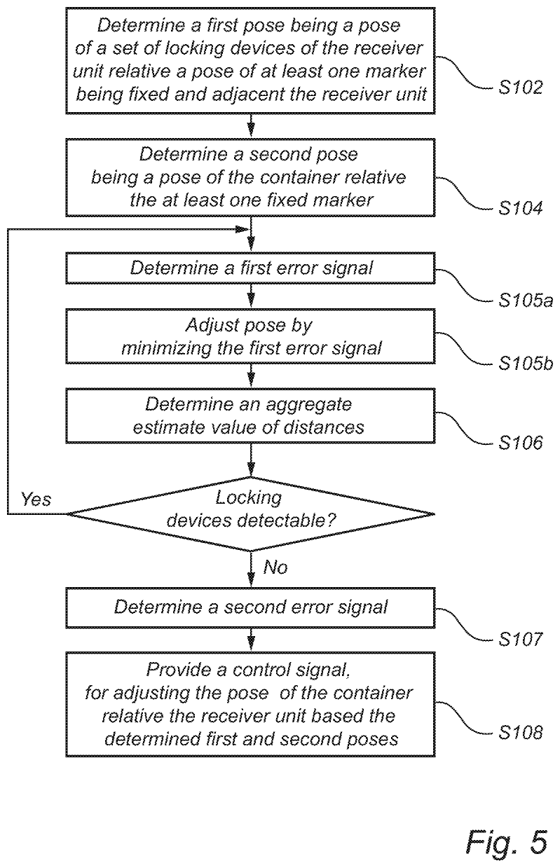

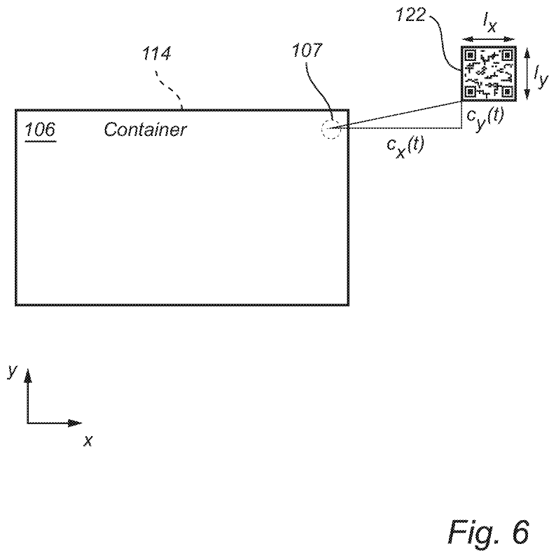

With reference to the flow-chart in FIG. 5 and the schematic top-views of the container 106, the receiving unit 114, and the marker 122 shown in FIGS. 3 and 6, an embodiment of the disclosure is now described in more detail.

In step S105a, determining a first error signal based on a difference in pose between the container 106 and the set of locking devices 116.

The control unit estimates the horizontal and vertical distances, âₓ(t), â_{y}(t), in the view seen by the sensor 120, between the twist lock 116 and the corner 107 of the container 106 that should attach to the twist lock, as well as the horizontal and vertical distances between the twist lock 116 and the land marker 122, \hat{b}ₓ, \hat{b}_{y}. Horizontal and vertical distances here refer to the x-axis and the y-axis in the plane-view of the sensor. Estimates of these distances in relation to the known dimensions of the land marker, l_{y}, l_{y}, can readily be obtained from a tracking system, especially if depth cameras 120 are used as sensors. The distances âₓ(t), â_{y}(t), are time varying whereas, \hat{b}ₓ, \hat{b}_{y} are fixed.

The estimated distances between the twist locks 116 and the container's corner 107 can be used to define the first error signal for the control unit:

$$ε ( t ) = \sqrt{{\hat{a}}_{x}^{2} ( t ) + {\hat{a}}_{y}^{2} ( t )}$$

Even if the tilt and panning angles of the camera 120 are not known exactly, the first error signal will approach zero as the container 106 gets closer to its target area where the twist locks 116 are located.

That is, in step S105b, control signal is provided to adjust the position of the container to minimize the first error signal (ε(t)) as the container 106 is lowered towards the receiver unit 114 while the set of locking devices 116 are detectable by the at least one sensor 120.

However, as the container 106 is lowered further, the twist locks 116 are eventually blocked from the sensor 120 by the container 106, as schematically shown in FIG. 6. Thus, if the locking devices 116 are detectable by the at least one sensor 122, the first error signal is used as feedback for positioning the container 106.

However, once the at least one locking device 116 of the receiving unit 114 is no longer in sight for the at least one sensor 120, a second error signal (ε′(t)) is determined, in step S107, based on a difference between the first pose and the second pose. The first pose is now a predetermined first pose.

The position of the receivers 110, e.g., receiving holes of the container 106 which receive the twist locks 116 are known relative a key point such as the corner 107 of the container. This information may be stored in a digital memory accessible to the control unit.

The distances between the twist lock 116 and the container corner 107, âₓ(t), â_{y}(t), are time-varying and should decrease as the container 106 is lowered.

However, the distances between the twist lock 116 and the land marker 122, \hat{b}ₓ and \hat{b}_{y} are constant since the truck 114 is assumed to be standing still. This means that multiple approximate values of \hat{b}ₓ and \hat{b}_{y} can be obtained during the container landing and that refined and accurate estimates can be found by, for example, considering the average of multiple samples. Advantageously, precise estimates of \hat{b}ₓ and \hat{b}_{y} can be made available at a later stage when the views of the twist locks 116 are lost.

In other words, the predetermined first pose, provided by \hat{b}ₓ and \hat{b}_{y} may preferably be determined while the locking devices 116 are detectable and the first error signal is used as feedback.

The method may include optional step S106 to determine an aggregate estimate value of multiple samples of a distance (\hat{b}ₓ and \hat{b}_{y}) between the set of locking devices and the at least one fixed marker while the locking devices 116 are detectable. The predetermined first pose is then based on the aggregate estimate values.

During this second stage of lowering the container 106, shown in the top view in FIG. 6, the views of the twist locks 116 get obstructed by the container 106.

At this point, the control unit no longer has access to estimates of âₓ(t) and â_{y}(t). However, estimates of the distances between the container corner 107 and the fixed marker 122, ĉₓ(t), ĉ_{y}(t), can be obtained, and since approximations of \hat{b}ₓ and \hat{b}_{y} are known from before, the second error signal can be passed to the controller.

ε′(t)={square root over ((ĉₓ(t)−\hat{b}ₓ)²+(ĉ_{y}(t)−\hat{b}_{y})²)}

This second error signal will also approach zero as the container 106 gets closer to its target area including the twist locks 116 and can thus be used to provide feedback during the final part of the container 106 set down.

The same procedure can be used for multiple spreader sensors such as cameras, and as long as two or more cameras are used, the identified landing location will be unique.

Step S108 thus includes adjusting the position of the container to minimize the second error signal as the container is lowered towards the receiver unit 114.

The control unit may be comprised in a control system of the spreader 100, either part of the spreader or a remote-control center of the spreader, or in a crane of the spreader.

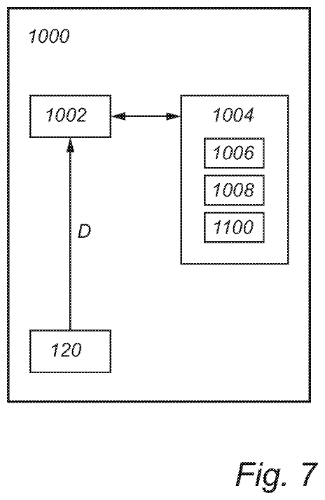

FIG. 7 illustrates a system 1000 for automated landing control of a container on a receiver unit comprising locking devices for the container.

The system comprises at least one sensor 120 for detecting poses of a set of locking devices 116 of a receiver unit 114 and fixed markers 122.

The system 1000 further comprises a control unit configured to acquire sensing data, D, from the at least one sensor 120. The control unit 1002 can determine, based on the sensing data D, the first pose 1006 and the second pose 1008 discussed herein. Data indicating the poses 1006 and 1008 can be stored on a digital memory 1004 accessible to the control unit 1002.

The steps of the methods described herein are performed by control unit 1002 embodied in the form of one or more microprocessors arranged to execute a computer program 1100 downloaded to the non-transitory computer readable storage medium 1004. The memory 1004 may be a Random Access Memory (RAM), a Flash memory or a hard disk drive.

A control unit 1002 may include a microprocessor, microcontroller, programmable digital signal processor or another programmable device. The control unit may also, or instead, include an application-specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which correspond to tangible media such as data storage media, or communication media including any media that facilitate the transfer of a computer program from one place to another, e.g., according to a communication protocol. In this manner, computer-readable media generally may correspond to (1) tangible computer-readable storage media which are non-transitory or (2) a communication media such as signal or carrier waves. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer.

Even though the invention has been described with reference to specific exemplifying embodiments thereof, many different alterations, modifications and the like will become apparent for those skilled in the art.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer implemented method for automated landing control of a container on a receiver unit comprising locking devices for the container, the method comprising the steps of:
determining, by a control unit, using the at least one sensor of a container handling device, a first pose being a pose of a set of locking devices of the receiver unit relative at least one marker being fixed and adjacent the receiver unit,
determining, by the control unit, using at least one sensor of the container handling device, a second pose being a pose of the container relative the at least one fixed marker, and
providing, by the control unit, a control signal, for adjusting the pose of the container relative the receiver unit based the determined first and second poses.

2. The method of claim 1, wherein the poses are determined in a reference frame of the at least one sensor.

3. The method of claim 1, comprising:
determining a first error signal based on a difference in pose between the container and the set of locking devices, and
adjusting the pose includes adjusting the horizontal position of the container to minimize the first error signal as the container is lowered towards the receiver unit while the set of locking devices are detectable by the at least one sensor.

4. The method of claim 1, further comprising:
determining a second error signal based on a difference between the first pose and the second pose, the first pose being a predetermined first pose, and
adjusting the pose includes adjusting the horizontal position of the container to minimize the second error signal as the container is lowered towards the receiver unit.

5. The method of claim 3, further comprising:
using the first error signal as long as the set of locking devices are detectable by the at least one sensor, and once the set of locking devices are no longer detectable, and
using the second error signal for adjusting the horizontal position of the container.

6. The method of claim 5, wherein the predetermined first pose is determined while the locking devices are detectable.

7. The method of claim 5, further comprising determining an aggregate estimate value of multiple samples of a distance between the set of locking devices and the at least one fixed marker while the locking devices are detectable, wherein the predetermined first value is the aggregate estimate value.

8. The method of claim 7, further comprising determining the aggregate estimate value while using the first error signal.

9. The method of claim 1, wherein the at least one fixed marker is a fiducial marker.

10. The method of claim 1, further comprising using at least two sensors, each associated with a corner of the container.

11. The method of claim 1, wherein the locking device is a twist-lock of a vehicle or trailer.

12. A system for automated landing control of a container on a receiver unit comprising locking devices for the container, the system comprising:
at least one sensor for detecting poses of a set of locking devices of a receiver unit and fixed markers, and
a control unit configured to carry out a method for automated landing control of the container on the receiver unit comprising locking devices for the container, the method comprising:
determining, by a control unit, using the at least one sensor of a container handling device, a first pose being a pose of a set of locking devices of the receiver unit relative at least one marker being fixed and adjacent the receiver unit,
determining, by the control unit, using at least one sensor of the container handling device, a second pose being a pose of the container relative the at least one fixed marker, and
providing, by the control unit, a control signal, for adjusting the pose of the container relative the receiver unit based the determined first and second poses.

13. A computer program product comprising computer-executable instructions that, when executed by a computer, cause the computer to carry out a method for automated landing control of a container on a receiver unit comprising locking devices for the container, the instructions comprising:
instructions for determining, by a control unit, using the at least one sensor of a container handling device, a first pose being a pose of a set of locking devices of the receiver unit relative at least one marker being fixed and adjacent the receiver unit,
instructions for determining, by the control unit, using at least one sensor of the container handling device, a second pose being a pose of the container relative the at least one fixed marker, and
instructions for providing, by the control unit, a control signal, for adjusting the pose of the container relative the receiver unit based the determined first and second poses.
